(19) United States
(12) Patent Application Publication
(10) Pub. No.: US 2008/0177638 A1
(43) Pub. Date: Jul. 24, 2008

(54) REAL TIME RE-PURPOSING OF A MOBILE APPLICATION USING XML DATA

(75) Inventor: Alfred L. Butler, Uxbridge, MA (US)

Correspondence Address: Vern Maine & Associates, 100 MAIN STREET, P O BOX 3445, NASHUA, NH, 03061-3445, US

(73) Assignee: Cyphermint, Inc., Marlborough, MA (US)

(21) Appl. No.: 12/013,496

(22) Filed: Jan. 14, 2008

Related U.S. Application Data
(60) Provisional application No. 60/884,656, filed on Jan. 12, 2007.

(51) Int. Cl. G06Q 30/00; G06F 15/16

(52) U.S. Cl. 705/26; 705/1; 709/203

(57) ABSTRACT

An online purchasing system has a host server with a merchant's database of products, prices, and operations, and user identifiers and accounts, linked to a banking system for tracking financial transactions. Users access the server for reviewing the merchant database and pre-selecting a subset of products defining a personalized user interface for later online purchasing activities, and storing it on the server. A thin client application for a mobile device provides for communicating with the server and receiving an XML-formatted data file defining the user's personalized user interface, and repurposing the mobile device user interface accordingly. User commands generated using the repurposed interface are sent to the server, executed, and an XML file representing the resulting update to the personalized user display is sent back to the mobile device, updating its own interface, all in real time, such that the remote execution of the command is transparent to the user.

This application claims priority to pending application 60/884,656 filed Jan. 12, 2007.

### BACKGROUND OF THE INVENTION

A third generation cell phone incorporating multi-functional PDA-like capabilities (personal digital assistant) is normally a small battery-powered computer intended to be carried around by the user as a portable or mobile device rather than left on a desk. It will be Internet enabled by wireless means for up and downloading of information and instructions. This means that the processor must be power-efficient as well as fast, and the operating system should be optimized for mobile, hand-held use. A user expects there to be a wide variety of mobile applications compatible with his operating system and device, available from the Internet or other sources, from which he may select, download and run programs appropriate to his requirements.

The operating system is the program that manages its internal resources. Common operating systems for cell phones and other PDA devices include Windows '95, MacOS, Linux, Solaris, AmigaOS, AIX, Windows NT, etc.

A mobile device such as a cell phone or PALM or Blackberry brand device is built to use a specific type of mid or lower level program technology. For example, Nokia builds their phones so that JAVA technology can be leveraged. The Blackberry, Sony-Ericsson and Motorola do the same. LG Electronics builds their phones so that BREW technology can be leveraged. The Motorola Q device supports the Windows Mobile technology. PALM intends to support JAVA. Different models of Nokia, Panasonic, and Sony-Ericsson support Symbian technology.

In order to allow a mobile application on a cell phone to communicate with a host system via the Internet, the mobile device must be Internet enabled. However, as described above, compatibility with standard programming protocols between different mobile devices is inconsistent. For example, one manufacturer's interpretation of a JAVA compatible standard may not be the same as another, meaning that an application may work on one manufacturer's JAVA powered device and not on another's.

Also, downloading an application to a mobile device takes up memory space. When it runs, it consumes more memory. The larger the application, the more memory it will require.

The term “thick client” generally indicates an application for a cellphone or PDA built to support a set of known commands or operations that can be used over the Internet. Depending on the development tool used the application can be produced in different sizes and thus takes up more or less space.

Running a command or operation on the cell phone could mean traversing many user interface forms or simply issuing a command over the Internet. It is inefficient and expensive to have to rewrite the same general application for dozens of different device formats; or to try to develop a unique variant of a mobile application for a limited group of devices. It is also inefficient to have to periodically update users' phones or other mobile devices with a fixed full set of commands or operations, many of which may not be used much of the time depending on the individual user's needs.

Data transfer between the server and the mobile device is another aspect of the process. XML is one standardized way to organize data. It has been in use for about 10 years and is well known, especially in Web technologies. XML serves more needs than just the interchange of data across systems; it is also widely used for stable data storage and as the foundation for other Web tools. Although nominally a “markup” language or “tagging” system, XML is a scheme for providing structure to information in a platform-neutral way, useful for such things as data structuring for online commerce.

A JAVA based, web-enabled, thin-client front-end has become a standard in the industry on how to present information to the end user. This architecture provides the greatest degree of flexibility, lower total cost of ownership for implementation and the web browser paradigm is widely understood by most end users within an organization. A web enabled front-end can be fully and completely configurable.

### SUMMARY OF THE INVENTION

It is a goal of the invention to enable merchants to present products to consumers via Internet-enabled personal mobile devices, and to enable consumers to perform financial operations such as purchase transactions or recharging financial accounts via access from the mobile device to a host system, using a methodology where all the mobile devices are able to communicate with the host system server in real time for re-purposing of the mobile application using a universal data document format or markup language such as XML data, irrespective of the specific client front end employed by the mobile device.

In one aspect, a portable, computer-based, wireless data communications terminal, used in cooperation with an internet-based electronic payment service, is used by consumers for numerous purposes including making online purchases and related financial transactions. The invention relates to providing users of such systems the ability to log in to their account at the server end and setup their own menu system there, for use on their mobile device.

The methods of the invention leverage the mobile browser in the user's mobile device in order to re-purpose or generate new menus for the user based on preferences previously established on the host system server and on the data specifying those preferences which is sent from the host server to the mobile device when requested. Applications for mobile devices will be able to leverage or take advantage of links to host systems to access and process the server data that defines the dynamic menus chosen by the consumer.

In one aspect of the invention, the dynamic content delivered to a mobile browser is basic HTML data. This basic content is purposely reduced to simple commands since the most simplistic browser should have no problem displaying the content. Regardless of what type of application is created, e.g. Java, BREW, SYMBION, etc., the server can send an XML envelope to the mobile application if requested.

After receiving this XML data the application will create the graphical user interface (GUI) dynamically as if it were pre-formed on the server or developed and built in an application on the mobile device.

Using this type of delivery system provides several benefits: the applications foot print is very small; the development time and cost is kept to a minimum; users can still create their own menus without penalty; and users have a wider choice of what mobile browser or mobile application they prefer to use.

In another aspect, the mobile device user's requirements may fall into four categories: input data; traverse to a new page; a label for information; and a button for execution. The mobile application simply reads the XML data and converts it into a readable and displayable form using that application's base technology.

The mobile device application reads the XML data received from the server and builds the user interface or UI at the mobile device in real time. The mobile device retains the same functionality for the user as if using a mobile browser.

The concept of a thin client mobile device is that the operations or commands do not reside in the application resident on the mobile device but are retrieved over the Internet from a host system server. For example, options can be provided through this interactive re-purposing process so that users can make selections, or a company's logo can be placed in the upper right hand corner of the end user screen. How the data is passed to this application is also of interest. A thin application must be aware of what it is receiving and how it needs to present the data to the user. It is an advantage to be able to load a thin client on the mobile device once and not have to have consumers have to reload a new version 90 days later.

These and other aspects of the invention will be apparent from the description and figures that follow.

### BRIEF DESCRIPTION OF THE FIGURES

FIG. 1 is an example of a menu displayed in the mobile browser of a handheld device.

FIG. 2 is a listing of source code as might generate the menu of FIG. 1.

FIG. 3 is a display of source code for the same menu of FIG. 1, based on an XML data envelope requested from the server in accordance with one aspect of the invention.

FIG. 4 is an example of XML data for logging in from a cell phone.

FIG. 5 is a flow chart depicting the merchant and consumer interactions with an Internet-based electronic payment system.

FIG. 6 is a flow chart depicting the engineering and user process flow for a thick client mobile device.

FIG. 7 is a flow chart depicting the engineering and user process flow for a thin client mobile device.

### DETAILED DESCRIPTION OF THE INVENTION

The invention is susceptible of many examples, variations and embodiments. What follows is a description illustrative of preferred embodiments but not exhaustive of the scope of the invention. The term “user” and “consumer” are used interchangeably unless the context admits otherwise.

A thin client application for a mobile device such as an Internet-enabled PDA or cell phone can be thought of as an empty shell. It knows of one thing to do upon startup and that is to make a connection to a server via the Internet and retrieve data from the server defining what to display. Thus the resident application is smaller in size and when run it takes up less memory as opposed to a thick application that contains its own pre-defined GUI menus.

The thin application understands a small set of rules to produce a list of commands or operations. How this data is created is specific to that mobile device's manufacturer. Thus a JAVA and BREW application has its own set of rules. However, XML data is of the same rules based format.

Example: <TEXT FIELD size=10></TEXT FIELD>

This line of instruction informs the thin client to create a text field 10 characters long on the user's display.

The system and methodology of the invention allows the consumer to leverage an Internet-ready mobile device and log into a host system server to retrieve their own set of commands or operations, using an XML or similarly formated file. These settings are added or removed by way of account access and instructions at any time, and may be accomplished using the mobile device or other computer having a more efficient and flexible user interface such as a PC (personal computer) with keyboard and mouse.

Extensible Markup Language or XML as it is known, is a widely used example of a general purpose data document format or markup language, that provides a way to combine a text and extra information about it. The extra information, including structure, layout, or other information, is expressed using markup, which is typically intermingled with the primary text. It allows users to define their own elements. Its primary purpose is to facilitate the sharing of structured data across different information systems including the Internet. It is used both to encode documents and to serialize data. In the latter context, it is comparable with other text-based serialization languages. For purposes of this disclosure, the term XML is intended to be inclusive of similar and derivative universal data document formats or markup languages, however they may be identified.

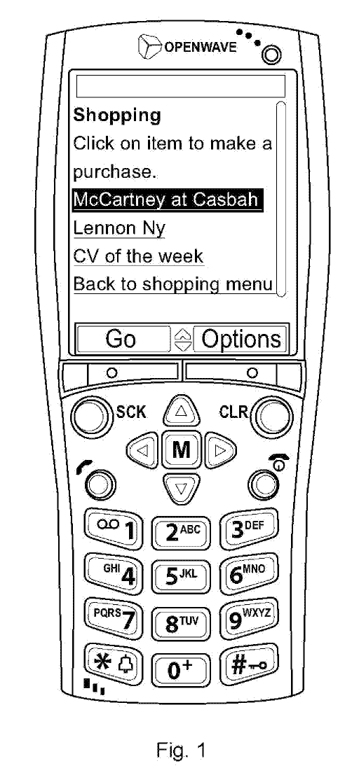

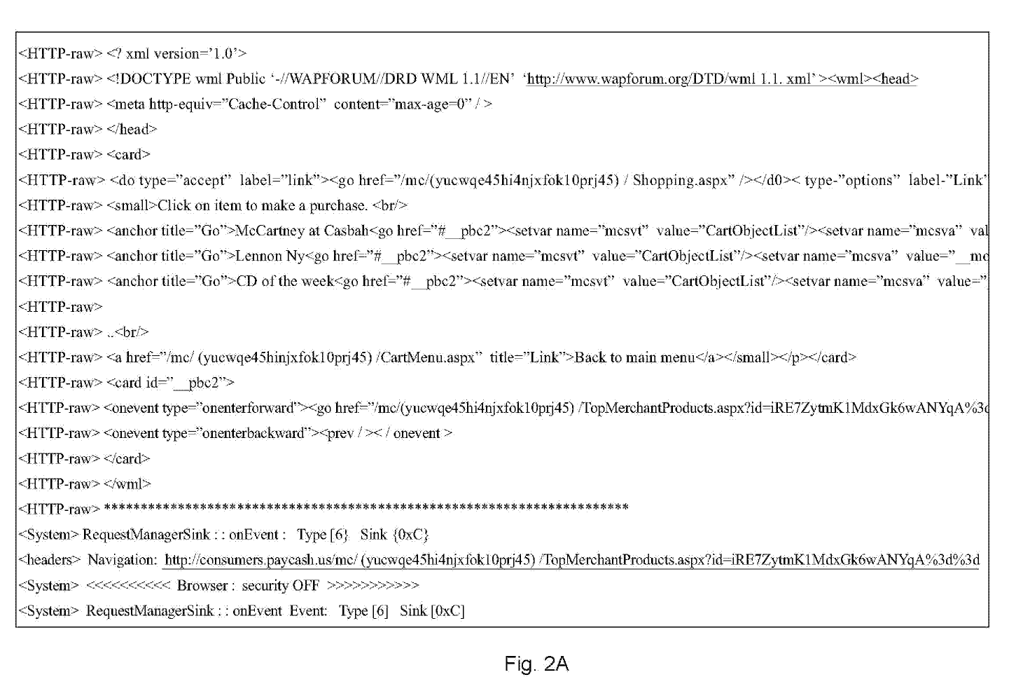

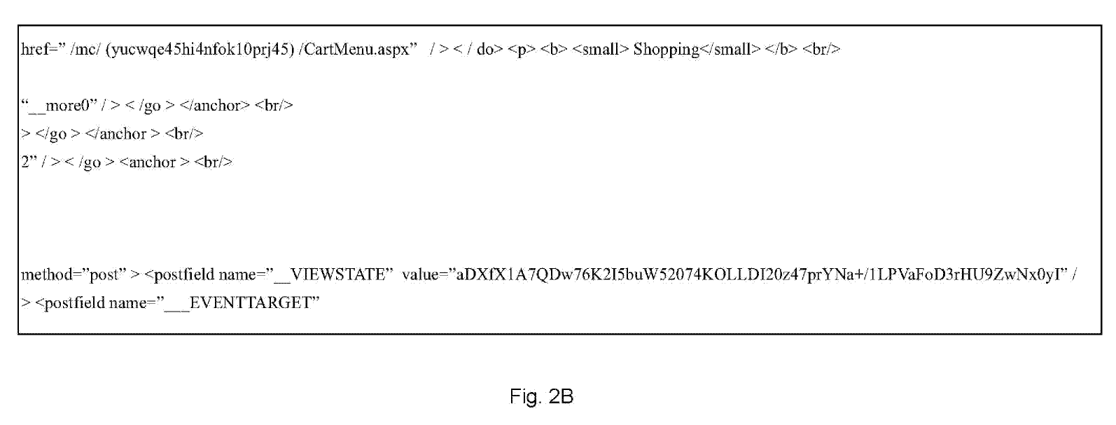

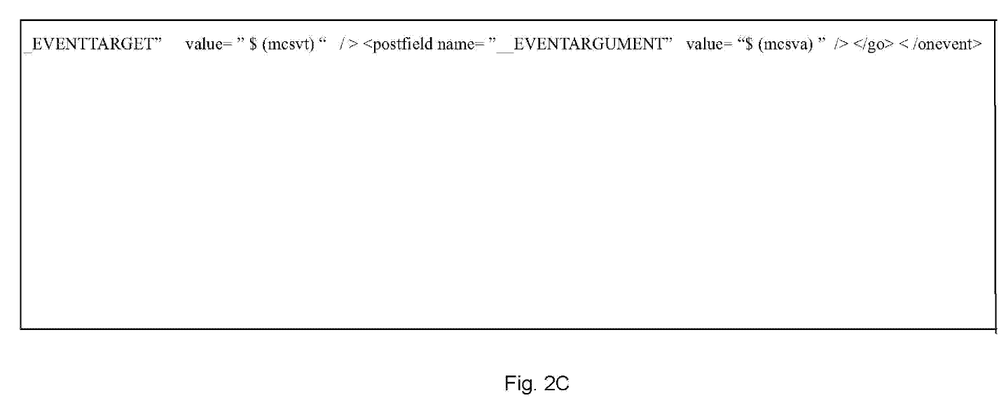

Referring to FIGS. 1 and 2, after user log in, data sent from the server to a mobile device is of two forms. The first form is used to leverage each mobile device Internet browser to read basic HTML commands as in FIG. 2, that produce menus as in FIG. 1. The data being displayed can also be used on a PC browser; there is no specific limitation to the mobile device's technology other than the basic ability to request, receive and execute the HTML commands.

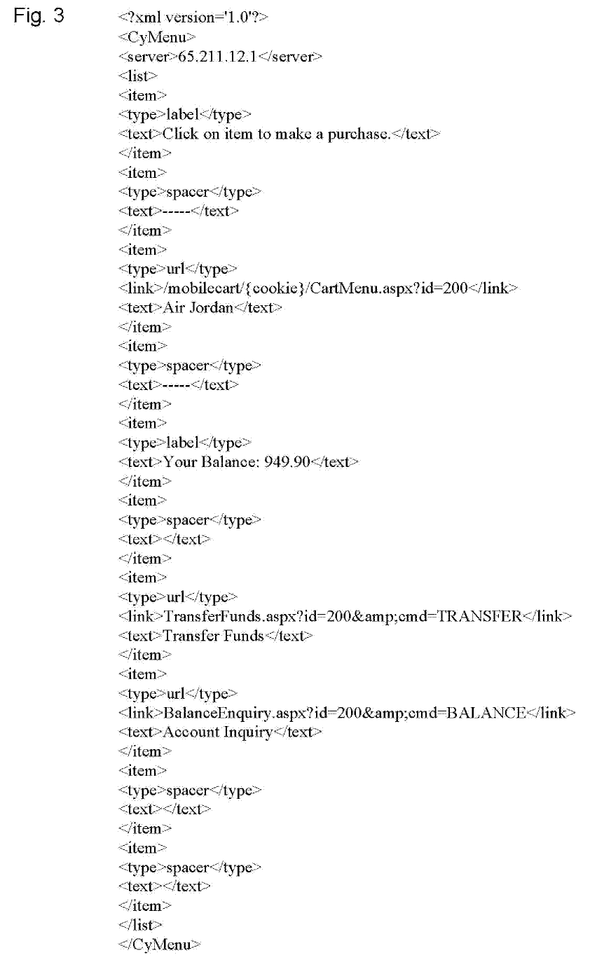

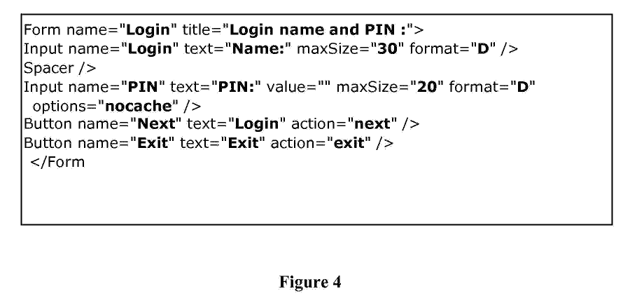

The second form is XML or similarly formatted data as in FIG. 3, sent to an already installed thin client application on the mobile device, that produces the same results as if the user were using the Internet browser. This thin client application is “XML aware”; having an XML parser that enables it to read the XML and then present the correct UI and data to the user as illustrated in FIG. 1.

The objective of the thin client application as opposed to a thick client application is to enable the mobile user to use the mobile browser or application to conduct the desired functions and transactions on his mobile device, phone or PDA; and to allow the mobile user to create or customize his own menus on the server side and enjoy the benefits of using a thin client application that recreates those menus in real time on the mobile device when required.

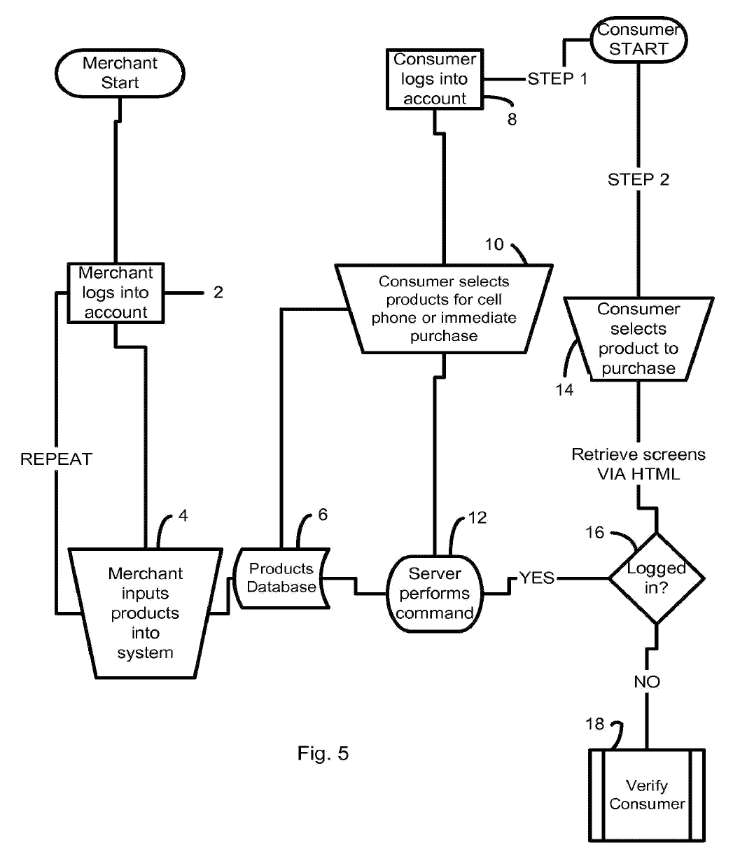

Referring to the process of FIG. 5, in one current system a merchant using a PC or other terminal device logs at (2) into his account and inputs to the service's server system at (4) his available products and services. A merchant's offering may be its full inventory or a selected subset, listed under the Merchant's name. It may also be further subdivided or dividable in a single or multi-tiered manner by key words such as brand names or product categories. This mode of access and selection is very familiar to online consumers. Multiple merchants may participate in the service.

In the system of FIG. 5, the consumer, in a first or set-up stage, has the ability to use his PC browser from a mobile or fixed terminal to log into his account at (8), view the entire database of merchant offerings with his browser and “build” a personal mobile screen or menu (10) of merchant offerings by selecting by appropriate keywords for the subsets or venues of products and services and related commands that he wishes to have readily available to him on his mobile device. This personalized menu is saved in an HTML data format on the server side at (6) so when the consumer logs into his account using his mobile device, the server will retrieve (16) and forward that saved data (6) in its HTML format, and the mobile application will generate the screens locally from the HTML data and function accordingly.

As noted, the default mode for this prior art system is to send HTML back to the calling device where a local menu or screen is generated. However, as will be discussed further, when the server recognizes a thin-client application log in request according to the invention, as opposed to a thick-client application request, it will send back to the calling device an XML data file defining the code required to access the personalized menu or screen in real time from the server side of the system, using the mobile browser.

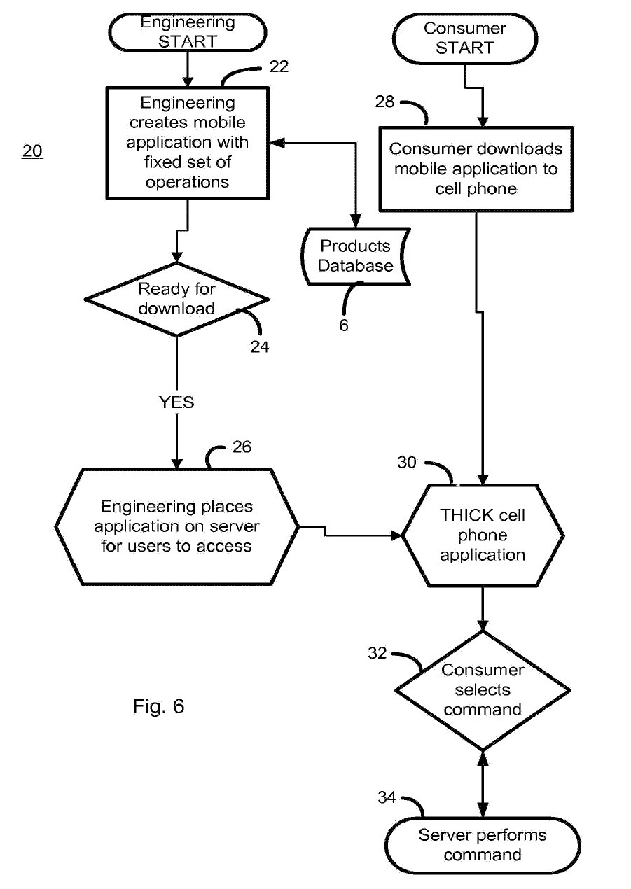

Referring now to FIG. 6, there is illustrated the building of a mobile application based upon a fixed set of operations, referred to as a “thick” application. Engineering develops a “thick” application (22) of screens and commands, until it is ready for download (24), and then places the application on a service server (26) available for internet access to subscribers of the service for downloading to a mobile device. The subscriber/consumer downloads and installs (28) the mobile application to its cell phone device. The consumer then starts and uses the application (30), and its screens and menus, selecting (32) from among the available, pre-programmed command options and choices, which are directed to the server when selected, and performed (34). There is no dynamic retrieval of anything, as the resident application is complete, its list of available commands fixed and inflexible.

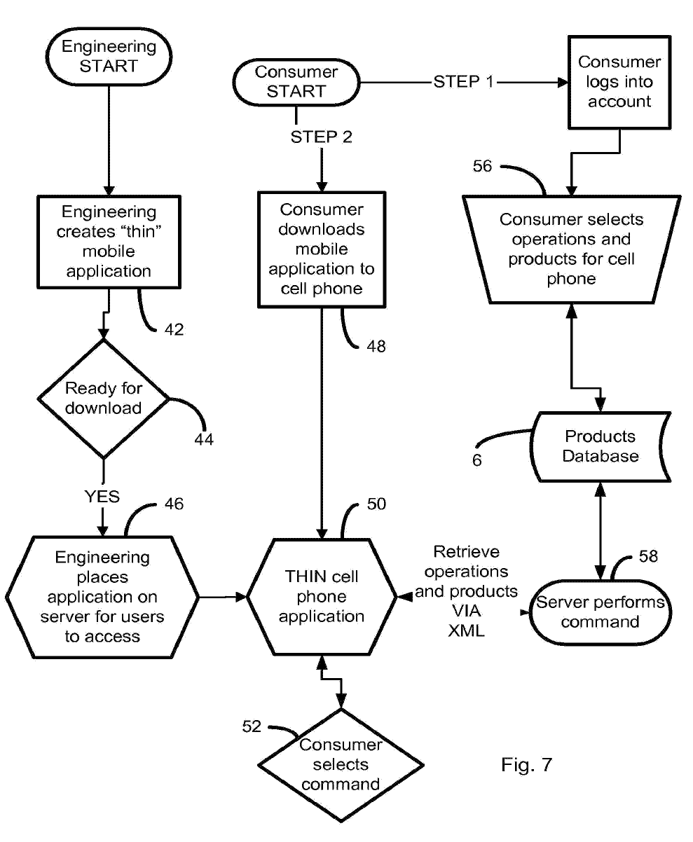

Referring now to FIG. 7, there is illustrated one embodiment of the invention, utilizing a thin client application methodology. In this embodiment, the engineering component creates an application for the mobile device, ignoring the availability of operations or products. These operations and products are selected later by the consumer in his set up stage.

Still referring to FIG. 7, the engineering component creates the “thin client” application (42), confirms that it is ready for download (44), and places it on the service's servers (46) available to subscribers to the service for download to their mobile devices. The subscriber/consumer, in the first part of set-up process, has the ability to use his PC or cell phone browser to log into his account to view the entire database of merchant offerings with his browser and “build” a personal mobile screen or menu (56) of merchant offerings by selecting by appropriate keywords for the subsets or venues of products and services and related operations that he wishes to have readily available to him on his mobile device. The selected choices or personalized menu (56) is saved on the server as product database (6). The user can at any time go back and revise the personal menu. In the second part of the set up process, the user next initiates communication to the server via his mobile device and downloads (48) the mobile “thin client” application and installs it on his device. He is now ready to enjoy the benefits of the consumer service enterprise by means of the thin client application on his mobile device and re-purposing capability of the XML data link with the pre-selected user menus on the server side.

The consumer starts and uses the thin client application (50), which in real time communicates with the server and receives the personalized menu of products and operations via an XML file, by which it builds a local copy or user interface screen defined by his pre-selected screens and menus of product database (6). The user's further selection of products and operations that appear to be occurring on the mobile device are in fact being done at the server in real time via the thin client link to the server.

Put more simply, the consumer turns on the application on his mobile device; the application makes contact to the server. The server recognizes who the consumer is and looks into the product/operations database and pulls the saved products and operations menu out of the database. The data is formed into XML data, sent back to the thin application. From the screens thus generated at the mobile device, the user inputs his desired transactions, which are communicated to the server and executed at the server side in real time, with the screen updates being passed via XML back to the mobile device such that it is a virtual representation of what is actually being done on the server. When the consumer session is over, and the application is closed, no information is or need be retained on the mobile device.

The invention includes other and various embodiments equivalent to and within the scope of the claims that follow. For example, there is a method by which users can remotely command selected computer-executable operations on a server using a mobile device, consisting of creating a user identify for each of the users on a computer server; where at least one user accesses the server and pre-selects a personal subset of whatever computer-executable operations are available using the server, such as purchases or control functions or making other arrangements via the server's connections to a network or to other computers or systems. The pre-selected subset of operations is stored on the server as a personalized user interface for mobile access by that user. The server program has the capability to encode the personalized user interface in an XML-formatted file for distribution to a remote user's device.

There is in conjunction with this method, a thin client computer application available for installation, or already installed, on an Internet-enabled mobile communications device, for communicating with the server. Importantly, it further provides for repurposing and updating of the mobile device interface based on the XML-formatted data file which it receives from the host server.

Initiating the thin client application on the mobile device enables it to communicate with the host server, to first confirm a user identity, and receive an XML-formatted data file by which its mobile device interface is repurposed to correspond to the respective personalized user interface stored on the host server. The user then selects computer-executable operations from the pre-selected subset of operations using the repurposed mobile device interface on the mobile device, thereby sending commands for the selected computer-executable operations from the mobile device to the server. The commands for the selected computer-executable operations received from the mobile device are then executed by or from the server in real time. The personalized user interface on the server is then updated with any changes resulting from execution of the selected operations. An XML-formatted data file corresponding to the change in the personalized user interface on the server is then sent back to the mobile device in real time. And finally the thin client application updates the repurposed mobile device user interface in real time consistent with the change on the server.

The computer-executable operations of this embodiment may be purchase agreements between the users and merchants, where the users are purchasers buying good and services using their mobile devices such as PDA's and/or cellular phones. The methods may include creating on the server a user account for each user identity. The methods may include linking or loading into the server a unique merchant identifier for each of the merchants, along with respective merchant account information, and loading or linking the server to or with an associated merchant database representing each merchant's inventory of available products, prices, and operations by which product selections and purchase operations can be executed. The methods may further include linking the server to a banking system with merchant and user accounts such that online purchases and related financial transactions can be conducted via the server, and respective accounts of merchants and users be maintained, as will be readily appreciated by those skilled in the art. Pre-selecting for the set up of the limited subset, as well as the act of selecting from the subset may include the use of key word searches, including selecting by the user from among the pre-selected subset of merchants' products and operations using a mobile device with a repurposed mobile device interface.

In other embodiments, the users may be workers or technicians of a common industry or a common employer or agency, or soldiers, or students of a common subject matter, or of a common school or geographic region, or other class of users with a common need for maintaining mobile access to computer-based information and selecting computer-executable options from among a personalized subset of a global or system wide command options. The merchant described above may be characterized as an agent or owner of the common database, and may in the alternative be an employer, or group of employers, or a government agency or school or group of schools, for example.

Another example of a method of the invention includes a method for conducting online retail purchasing activities with a mobile device consisting of using an Internet-enabled host server online purchasing system; loading at least one merchant identifier and respective merchant account and loading or linking with an associated database representing that merchant's inventory of available products, prices, and operations by which product selections and purchase operations can be indicated; loading a plurality of identified users and respective user accounts; and linking the online purchasing system to a banking system such that online purchases and related financial transactions can be conducted via the online purchasing system and respective accounts of merchants and users be maintained by both systems. Users are permitted online access to the host server for reviewing the at least one merchant database representing products and operations, and pre-selecting from the database by each individual user a subset of the database defining a personalized user interface for subsequent access and purchases. The system then stores data defining the personalized user interface on the server.

A thin client application for mobile devices is placed on the server for access by subscribing users for downloading to their mobile devices. The application is configured to repurpose the local user interface according to an XML-formatted data input it receives from the host server. A copy of the thin client application is downloaded and installed on a user's mobile device. The application is started, where upon it communicates with the host server, receives XML-formatted data defining the respective personalized user interface stored on the host server, and repurposes the mobile device user interface according to the XML-formatted data.

The user is then able to select products and operations using the mobile device user interface and sending commands for the selected products and operations from the mobile device to the host server. The received commands are executed at the host server in real time, and the stored data defining the respective personalized user interface on the host server is updated. The server then sends back to the mobile device in real time an XML-formatted data update representing the update to the stored data, and the mobile device user interface is updated with the result in real time.

There is yet another example of the invention in the form of a remotely operable computer system for users of mobile devices. It includes an Internet-enabled server that is linked to or loaded with a database representing user selectable computer-executable operations. It has means by which users can access the server for reviewing the database of operations and pre-selecting therefrom a personal subset of operations, thereby defining a personalized user interface for commanding a selected computer-executable operation from among the subset of operations. The personalized user interface is associated with a user identity and stored on the server.

There is a thin client application for a mobile device, which in combination with a mobile device provides means for communicating with the server via the Internet, confirming a user identity, receiving an XML-formatted data file defining the associated personalized user interface as stored on the server, repurposing the mobile device user interface according to the personalized user interface. The mobile device operated by the thin client application, communicates user commands via the personalized user interface and its wireless, Internet capability to the server, and receives from the server an XML-formatted data file representing the resulting update to the personalized user display. It then updates the repurposed mobile device user interface accordingly. The thin client application is available to the users by any number of means such as by online download, or fixed mediums such as compact disks or other storage devices, for installing on a mobile device.

The server may be loaded with at least one merchant identifier and respective merchant account information, and/or with another type of agent or owner of a database to which users need access. The database representing user selectable computer-executable operations may be at least one merchant's inventory of available products, prices, and operations by which product selections and purchase operations can be indicated. In other embodiments, it may be, for example, food selections, health care selections, communications or navigation selections, or work instructions. The server may be loaded with a plurality of user identifiers and respective user accounts, and may be linked to a banking system, or other third party system, whereby online purchases or other operations can be conducted by the users via the server and respective accounts of merchants and users be maintained. There may be access by users to the server for reviewing the at least one merchant database representing products and operations, and pre-selecting from among the products a user's own subset of products, thereby defining a personalized user interface for online purchasing activities. The personalized user interface may be stored on the server.

Other various and equivalent embodiments are within the scope of the invention and the claims that follow.

What is claimed is:

1. A method for remotely commanding computer-executable operations on a server using a mobile device, comprising:
creating a user identify for each of a plurality of users on a server;
at least one user accessing the server and pre-selecting a personal subset of computer-executable operations from among the available computer-executable operations;
storing the pre-selected subset of operations on the server as a personalized user interface for mobile access by said user;
installing on a mobile device a thin client application adaptable for communicating with the server and repurposing and updating of its mobile device interface based on XML-formatted data received from the host server;
initiating the thin client application on the mobile device whereby it communicates with the host server, confirms a user identity, and receives XML-formatted data by which its mobile device interface is repurposed to correspond to the respective personalized user interface stored on the host server;
selecting computer-executable operations using the repurposed mobile device interface on the mobile device, thereby sending commands for the selected computer-executable operations from the mobile device to the server;
executing from the server in real time the received commands for the selected computer-executable operations;
updating the personalized user interface on the server with any changes resulting from execution of the selected operations;
sending back to the mobile device in real time XML-formatted data corresponding to the change in the personalized user interface on the server; and
updating the mobile device user interface in real time.

2. The method of claim 1, said computer-executable operations comprising purchase agreements between said users and merchants.

3. The method of claim 2, further comprising
loading into the server a unique merchant identifier for each said merchant with respective merchant account information, and loading or linking the server with an associated merchant database representing each said merchant's inventory of available products, prices, and operations by which product selections and purchase operations can be executed;
creating on the server a user account for each user identity;
linking the server to a banking system with merchant and user accounts such that online purchases and related financial transactions can be conducted via the server, and respective accounts of merchants and users be maintained.

4. The method of claim 3, said pre-selecting comprising the use of key word searches accessing all merchant databases.

5. The method of claim 4, said selecting comprising selecting by the user from among the pre-selected subset of merchants' products and operations using a mobile device with a repurposed mobile device interface.

6. The method of claim 5, said executing from the server in real time the received commands for the selected purchases and operations.

7. The method of claim 6, said mobile device comprising a battery powered, handheld, computer-based, Internet-enabled, wireless communications device.

8. The method of claim 6, said mobile device comprising a cellular telephone.

9. The method of claim 1, said thin client application being a JAVA-based application.

10. The method of claim 1, said thin client application being a BREW-based application.

11. The method of claim 1, said thin client application being a SYMBION-based application.

12. A method for conducting online retail purchasing activities with a mobile device comprising:
using an Internet-enabled host server online purchasing system;
loading at least one merchant identifier and respective merchant account and loading or linking with an associated database representing that merchant's inventory of available products, prices, and operations by which product selections and purchase operations can be indicated;
loading a plurality of identified users and respective user accounts;
linking the online purchasing system to a banking system such that online purchases and related financial transactions can be conducted via the online purchasing system and respective accounts of merchants and users be maintained by both systems;
permitting online access by the users to the host server for reviewing the at least one merchant database representing products and operations;
pre-selecting from the database by each individual user a subset of the database defining a personalized user interface for subsequent access and purchases;
storing data defining said personalized user interface on the server;
loading a thin client application for mobile devices on the server for access by subscribing users for downloading to a mobile device, said application programmed for repurposing the local user interface according to an XML-formatted data input;
downloading and installing on a user's mobile device a copy of the thin client application;
initiating the thin client application on the mobile device whereby it communicates with the host server and receives XML-formatted data defining the respective personalized user interface stored on the host server;
repurposing the mobile device user interface according to the XML-formatted data;
selecting by the user of products and operations using the mobile device user interface and sending commands for the selected products and operations from the mobile device to the host server;
executing at the host server in real time the received commands for the selected products and operations;
updating the stored data defining the respective personalized user interface on the host server;
sending back to the mobile device in real time an XML-formatted data update representing the update to the stored data; and
updating the mobile device user interface with the result in real time.

13. A remotely operable computer system for users of mobile devices comprising:
an Internet-enabled server, said server linked or loaded with a database representing user selectable computer-executable operations;
means of access by users to said server for reviewing the database of operations and pre-selecting therefrom a personal subset of operations, thereby defining a personalized user interface for commanding a selected computer-executable operation from among the subset of operations, said personalized user interface being associated with a user identity and stored on the server; and
a thin client application for a mobile device; said application comprising in combination with a mobile device means for communicating with the server via the Internet, confirming a user identity, receiving an XML-formatted data file defining the associated personalized user interface as stored on the server, repurposing the mobile device user interface according to the personalized user interface, communicating user commands via the personalized user interface to the server, receiving from the server an XML-formatted data file representing the resulting update to the personalized user display, and updating the repurposed mobile device user interface accordingly; said thin client application being available to said users for installing on a mobile device.

14. The system of claim 13, further comprising:
a plurality of Internet-enabled, mobile devices configured for wireless communications, each having the thin client application installed thereon.

15. The system of claim 13, said server loaded with at least one merchant identifier and respective merchant account information, said database representing user selectable computer-executable operations comprising at least one merchant's inventory of available products, prices, and operations by which product selections and purchase operations can be indicated, said server being loaded with a plurality of user identifiers and respective user accounts; said server being linked to a banking system whereby online purchases can be conducted by the users via the server and respective accounts of merchants and users be maintained.

16. The system of claim 14, said means of access by users comprising access by users to said server for reviewing the at least one merchant database representing products and operations, and pre-selecting from among the products a user's own subset of products, thereby defining a personalized user interface for online purchasing activities, said personalized user interface being stored on the server.

17. An online purchasing system for users of mobile devices comprising:
an Internet-enabled host server, said server loaded with at least one merchant identifier and respective merchant account and linked or loaded with an associated database representing that merchant's inventory of available products, prices, and operations by which product selections and purchase operations can be indicated, said server loaded with a plurality of user identifiers and respective user accounts; said server being linked to a banking system whereby online purchases can be conducted by the users via the server and respective accounts of merchants and users be maintained;
means of access by users to said server for reviewing the at least one merchant database representing products and operations, and pre-selecting from among the products a user's own subset of products and thereby defining a personalized user interface for online purchasing activities, said personalized user interface being stored on the server; and
a thin client application for a mobile device; said application comprising in combination with a mobile device means for communicating with the server via the Internet, confirming a user identity, receiving an XML-formatted data file defining that user's personalized user interface as stored on the server, repurposing the mobile device user interface accordingly, communicating user commands to the server, receiving from the server an XML-formatted data file representing the resulting update to the personalized user display, and updating the mobile device user interface accordingly; said thin client application being accessible via Internet for downloading to an Internet-enabled mobile device.

18. The system of claim 17, said thin client application configured for real time communications with said server whereby user commands inputted on the repurposed mobile device interface are sent to the server and executed thereon, and the result sent back to the mobile device and its repurposed mobile device interface updated in such time that the remote execution of said command is transparent to the user.
